(19) United States
(12) Patent Application Publication
(10) Pub. No.: US 2003/0197682 A1
(43) Pub. Date: Oct. 23, 2003

(54) Computer mouse having variable size

(76) Inventor: Yao-Lun Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/127,673

(22) Filed: Apr. 23, 2002

(51) Int. Cl. G09G 5/08

(52) U.S. Cl. 345/163

(57) ABSTRACT

A computer mouse includes a mouse body of a generally known configuration and construction and a size-changing means attached to the mouse body for selectively changing the overall size of the computer mouse. The size-changing means may be a jacket made of a flexible material having a predetermined thickness and fit over the mouse body. Alternatively, a hermetic bag is formed with the jacket and has a nozzle for filling air into the bag to selectively inflate the bag so as to change the overall size of the mouse. Alternatively, the size-changing means includes a number of inflatable members mounted to the mouse body. The inflatable members are selectively inflated/deflated to change the overall size of the computer mouse. A cover can be attached to the inflatable members whereby the inflation of the inflatable members moves the cover away from the mouse body and thus increasing the overall size. Deflation of the inflatable members moves the cover toward the mouse body and thus decreasing the overall size.

### BACKGROUND OF THE INVENTION

1. Field of the Invention

The present invention generally relates to a computer mouse, and in particular to a computer mouse having a variable size.

2. The Related Art

Computer mice are one of the most commonly employed computer-input devices or man-machine interfaces. Studies suggest that the size of a computer mouse is better to be as large as possible for the protection of a user's wrist and hand. The smaller the size of the computer mouse is, the more likely it is to damage the user's wrist.

In practice, it is always found that a fixed size computer mouse is not suitable for users of different ages. For example, a computer mouse having a size for an adult is not suitable for a young child for the child's hand is smaller than the adult's hand. Heretofore, such a problem is overcome by providing different mice for different users. This, of course, is very troublesome.

Thus, it is desired to provide a computer mouse that overcomes the above problems.

### SUMMARY OF THE INVENTION

An object of the present invention is to provide a computer mouse having a variable size.

Another object of the present invention is to provide a computer mouse that is suitable for both adults and children.

To achieve the above objects, in accordance with the present invention, there is provided a computer mouse comprising a mouse body of a generally known configuration and construction and a size-changing means attached to the mouse body for selectively changing the overall size of the computer mouse. The size-changing means may be a jacket made of a flexible material having a predetermined thickness and fit over the mouse body. Alternatively, a hermetic bag is formed with the jacket and has a nozzle for filling air into the bag to selectively inflate the bag so as to change the overall size of the mouse. Alternatively, the size-changing means comprises a number of inflatable members mounted to the mouse body. The inflatable members are selectively inflated/deflated to change the overall size of the computer mouse. A cover can be attached to the inflatable members whereby the inflation of the inflatable members moves the cover away from the mouse body and thus increasing the overall size. Deflation of the inflatable members moves the cover toward the mouse body and thus decreasing the overall size.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a computer mouse constructed in accordance with a first embodiment of the present invention;

FIG. 2 is an exploded view of the computer mouse of the present invention;

FIG. 3 is an exploded view of a computer mouse constructed in accordance with a second embodiment of the present invention;

FIG. 3A is an enlarged view of encircled portion 3A of FIG. 3;

FIG. 4 is an assembled view of the computer mouse of FIG. 3;

FIG. 5 is an end view of a computer mouse constructed in accordance with a third embodiment of the present invention;

FIG. 6 is an en d view of a computer mouse constructed in accordance with a fourth embodiment of the present invention in a deflated condition; and

FIG. 7 is similar to FIG. 6 but showing the computer mouse of the fourth embodiment in an inflated condition.

### DETAILED DESCRIPTION OF THE PREFERRED EMBODIMENTS

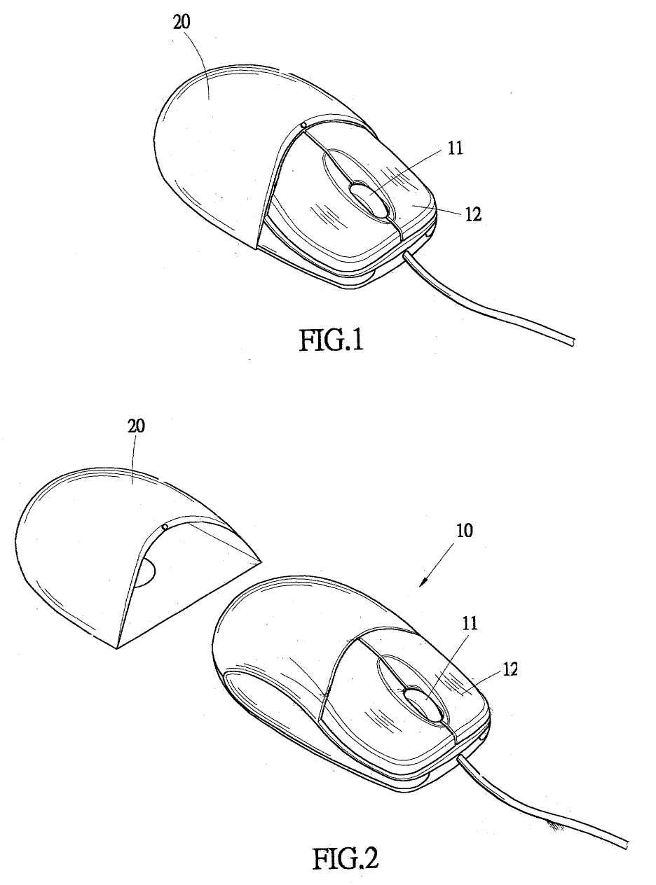

With reference to the drawings and in particular to FIGS. 1 and 2, a computer mouse constructed in accordance with a first embodiment of the present invention generally comprises a mouse body 10 having a generally known configuration and construction of conventional computer mice and a size-changing means, such as a jacket 20 removably fit over the body 10. The mouse body 10 comprises a number of pushbuttons 12 and a roller 11 mounted on a topside thereof and a detecting or sensing device (not shown) mounted to a bottom side thereof. The jacket 20 is made of a flexible material whereby the jacket 20 is retained on the mouse body 10 by means of for example friction therebetween. The flexible material that makes the jacket 20 has preferably a predetermined thickness. The jacket 20 is configured to expose the roller 11 and the pushbuttons 12 and the detecting device to allow the users access to the roller 11 and the pushbuttons 12 and to allow the engagement of the detecting device with for example a desk surface. By mounting the jacket 20 to the mouse body 10, the overall size of the mouse is substantially increased. By removing the jacket 20 from the mouse body 10, the size of the mouse is reduced.

It is apparent to those having ordinary skills to adapt a jacket 20 having different sizes to further change the overall size of the computer mouse.

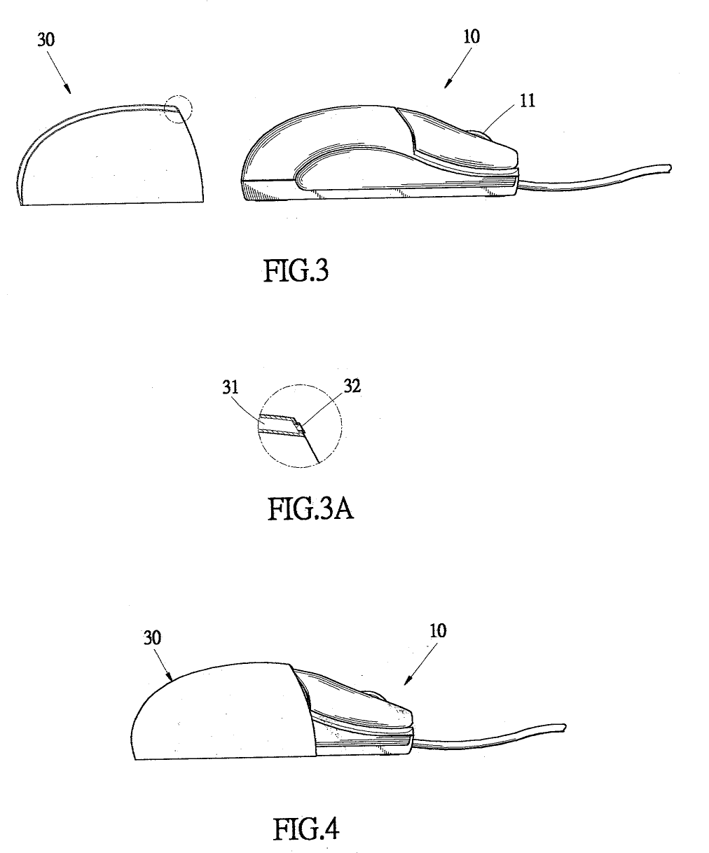

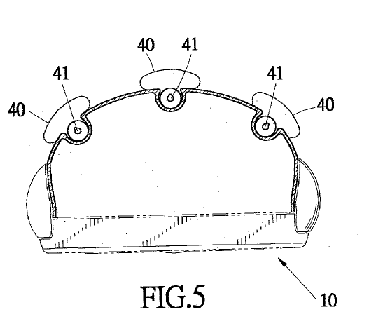

FIGS. 3 and 4 show a computer mouse constructed in accordance with a second embodiment of the present invention. The computer mouse of the second embodiment comprises a mouse body 10 over which a jacket 30 is fit. The jacket 30 comprises a hermetic bag 31 having a flat configuration. The bag 31 has a nozzle 32 through which air is filled into the bag 31 and thus inflating the bag 31. The inflation of the bag 31 increases the overall size of the computer mouse and the deflation of the bag 31 decreases the overall size.

FIG. 5 shows a computer mouse constructed in accordance with a third embodiment of the present invention. The computer mouse of the third embodiment comprises a mouse body 10 having a topside face on which a number of inflatable members 40 is mounted. The inflatable members 40 may have different sizes and shapes. Each inflatable member 40 has a nozzle 41 for filling air into the inflatable member 40. Inflation and deflation of the inflatable members 40 respectively increase and decrease the overall size of the computer mouse.

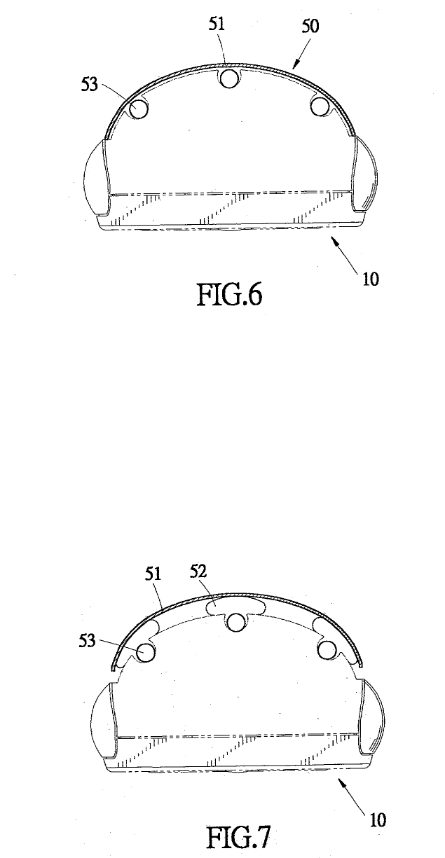

FIGS. 6 and 7 show a computer mouse constructed in accordance with a fourth embodiment of the present invention. The computer mouse of the fourth embodiment is a modification of the computer mouse of the third embodiment. The computer mouse of the fourth embodiment comprises a mouse body 10 to which inflation means 50 is provided. The mouse body 10 has a topside face and the inflation means 50 comprises inflatable members 52 mounted to the topside face by means of for example adhesives and ultrasonic welding. A cover 51 is attached to the inflatable members 52 whereby the inflatable members 52 are interposed between the top side face of the mouse body 10 and the cover 51. The inflatable members 52 each have a nozzle for filling air into the inflatable member to inflate the members 52 and thus moving the cover 51 away from the mouse body 10 thereby increasing the overall size of the computer mouse. By deflating the inflatable members 52, the cover 51 is moved toward the mouse body 10 and thus decreasing the overall size of the mouse body 10.

It is apparent to those having ordinary skills to inflate the inflatable members 52 to different extents in order to change the overall configuration and size of the computer mouse.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. A computer mouse comprising:
a mouse body which comprises a number of pushbuttons and a roller mounted on a topside thereof and a detecting or sensing device mounted to a bottom side thereof; and
a size-changing means that is attached to the mouse for selectively changing an overall size of the computer mouse, the size-changing means comprising a jacket releasably fit over the mouse body whereby mounting the jacket to the mouse body increases the overall size of the computer mouse and whereby dismounting the jacket from the mouse body decreases the overall size of the computer mouse.

2. The computer mouse as claimed in claim 1, wherein the jacket is made of a flexible material having a predetermined thickness.

3. The computer mouse as claimed in claim 1, wherein the jacket forms a hermetic bag having a nozzle adapted to fill air into the bag for expanding the bag to change the overall size of the computer mouse.

4. The computer mouse as claimed in claim 1, wherein the size-changing means comprises at least one inflatable member mounted to a topside face of the mouse body, the inflatable member being selectively inflated/deflated for changing the overall size of the computer mouse.

5. The computer mouse as claimed in claim 4 wherein the size-changing means comprises a number of inflatable members mounted to a topside face of the mouse body.

6. The computer mouse as claimed in claim 5, wherein the inflatable members have selectively different sizes and shapes.

7. The computer mouse as claimed in claim 5, wherein the size-changing means further comprises a cover mounted to the inflatable members.

8. The computer mouse as claimed in claim 7, wherein the inflatable members have selectively different sizes and shapes.
